(19) United States
(12) Patent Application Publication
(10) Pub. No.: US 2009/0053942 A1
(43) Pub. Date: Feb. 26, 2009

(54) CONDUCTION TERMINAL AND METHOD FOR TIN-DIPPING CONDUCTION TERMINAL

(75) Inventor: Chin Chi Lin, Keelung (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: LOTES CO., LTD, Keelung (TA)

(21) Appl. No.: 12/120,488

(22) Filed: May 14, 2008

(30) Foreign Application Priority Data
Aug. 22, 2007 (CN) 200710029838.3

(51) Int. Cl. H01R 4/02; H01R 43/00

(52) U.S. Cl. 439/874; 29/825

(57) ABSTRACT

The invention provides a conduction terminal, and the conduction terminal includes a weld part and a solder. The weld part includes an end surface and a side wall adjacent to the end surface. A solder film covers the end surface and the side wall. Compared with prior art, a solder on the weld part of the conduction terminal of the invention forms as a film. Therefore, the conduction terminal of the invention is easily welded on a substrate, and the conduction terminals do not easily have a short circuit and conjoined solders. Additionally, a method for tin-dipping the conduction terminal including the following steps of: providing a fixture having multiple storage troughs, sizes of the storage troughs are the same; disposing equivalent quantity of solder on each of the storage troughs; heating the fixture to melt the solders; inserting the weld parts of the conduction terminals into the corresponding accommodation holes, so as to stick the solder on the conduction terminal, and the solder covers as a solder film on the conduction terminal after cooling.

### FIELD OF THE INVENTION

The invention relates to a conduction terminal, and particularly relates to a conduction terminal densely accommodated in an insulation body. The invention further relates to a method for manufacturing a solder film on a weld part of the conduction terminal.

### BACKGROUND OF THE INVENTION

Most connectors are welded on a substrate by a solder on a weld part of a conduction terminal. Generally, the conduction terminal includes a connection part and a weld part. Most shapes of solders on the weld parts of the conduction terminals are spherical. Please refer to FIG. 1, which shows a shape of the weld part of a conduction terminal in the prior art. A thick solder 13 enwraps a solder film 12 of the weld part so as to form a tin-ball on the weld part of the conduction terminal 1.

Taiwan application No. 093115924 discloses a typical method for locating a tin-ball on a conduction terminal of an electrical connector. The shape of a solder on a weld part of the conduction terminal is spherical. Many conduction terminals are densely accommodated in an insulation body, and distances between adjacent conduction terminals are short, so a short circuit easily occurs during a welding process of the conduction terminal. Further, the shape of a solder on a conventional weld part is spherical, so the solders on the adjacent weld parts are easily conjoined during a welding process.

Therefore, there is a need to provide a new conduction terminal to solve the aforesaid problems.

### SUMMARY OF THE INVENTION

A purpose of the invention is to provide a conduction terminal, so that a weld part of the conduction terminal is easily welded on a substrate and the conduction terminals do not have a short circuit and are not conjoined. Additionally, another purpose of the invention is to provide a method for manufacturing a solder film of the conduction terminal.

In order to realize the aforesaid purposes, a conduction terminal of the invention includes a base, a weld part extending from the base and having an end surface and a side wall adjacent to the end surface, and a solder including a first solder film wrapping the end surface and a second solder film wrapping the side wall. A first weld region is defined on a surface of the first solder film, and a second weld region is defined on a surface of the second solder film.

The further improvement of the invention is that the second solder film enwraps the side wall of the weld part and the second weld region is defined annularly on the surface of the second solder film. A volume of the second weld region is larger than a volume of the first weld region. Quantities of solders on weld regions are sufficient, such that a conduction terminal can be tightly welded on a substrate.

In order to form a solder film on a weld part of a conduction terminal, the invention includes the following steps of: providing a fixture having a plurality of storage troughs; depositing a solder in the storage troughs, therein a surface tension of the solder stored in each of the storage troughs is able to be broken by a siphon force of the weld part of the conduction terminal predestined to be tin-dipped; heating the fixture to melt the solder stored in each of the storage troughs; and dipping the weld part of the conduction terminal into the storage trough, such that the solder sticks on the conduction terminal so as to form solder films respectively on an end surface and a side wall of the weld part, and the surface tension of the solder is broken by the siphon force of the weld part so as to form weld regions on surfaces of the solder films.

Compared with the prior art, the invention has obvious characteristics and advantages as the following. The solder on the weld part of the conduction terminal of the invention is a solder film, so the conduction terminal of the invention is easily welded on a substrate and there are no an occurrence of a short circuit and no an appearance of the solders of the conduction terminals conjoining during a welding process.

The invention provides a manufacture method utilizing a siphon force to break a surface tension of a solder film on an end surface of a weld part and improving the technique of a fixture and of supplying a fixed quantity of a solder. Therefore, it is realized to remove the solder which is enough to form a tin-ball on the weld part.

The advantage and spirit of the invention may be understood by the following recitations together with the appended drawings.

### BRIEF DESCRIPTION OF THE DRAWINGS

FIG. 1 is a pictorial diagram illustrating a conduction terminal with a tin-ball on the weld part thereof.

FIG. 2 is a schematic diagram illustrating a tin-dipping of a conduction terminal by a siphon force.

FIG. 3 is a pictorial diagram illustrating a single conduction terminal before tin-dipping.

FIG. 4 is a pictorial diagram illustrating a plurality of conduction terminals before tin-dipping.

FIG. 5 is a pictorial diagram illustrating the single conduction terminal shown in FIG. 3 after tin-dipping.

FIG. 6 is a pictorial diagram illustrating the conduction terminals of the invention after being fixed on an insulation body and before being installed on a substrate.

FIG. 7 is a pictorial diagram illustrating the conduction terminals shown in FIG. 6 after being installed on the substrate.

FIG. 8 is a cross-sectional view through lines A-A of a single conduction terminal of the invention.

### DETAILED DESCRIPTION OF THE INVENTION

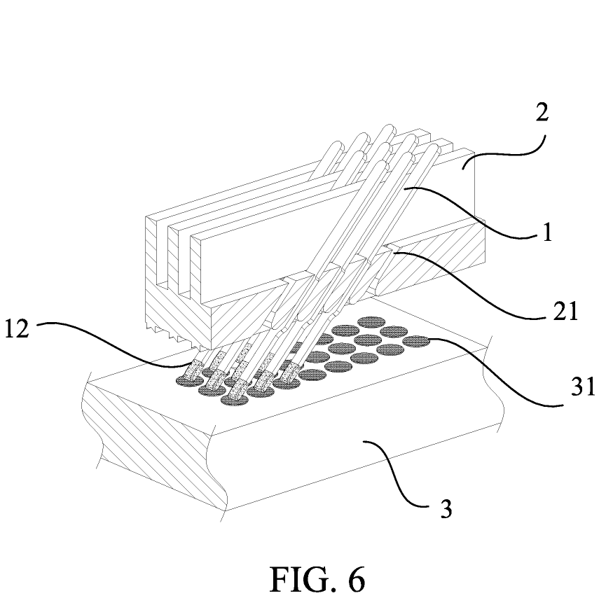

Please refer to FIG. 6. There are a plurality of accommodation holes 21 on an insulation body 2 and corresponding to conduction terminals 1. The accommodation holes 21 and the conduction terminals 1 are arranged at a tilt. There are a plurality of conduction holes 31 corresponding to the conduction terminals 1 and on a substrate 3 for accommodating the conduction terminals 1 of the invention.

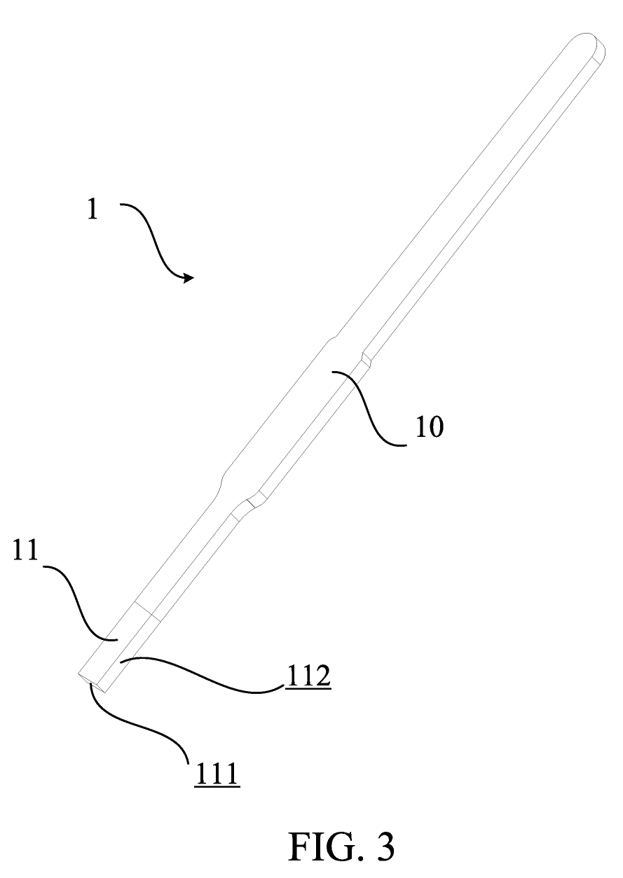

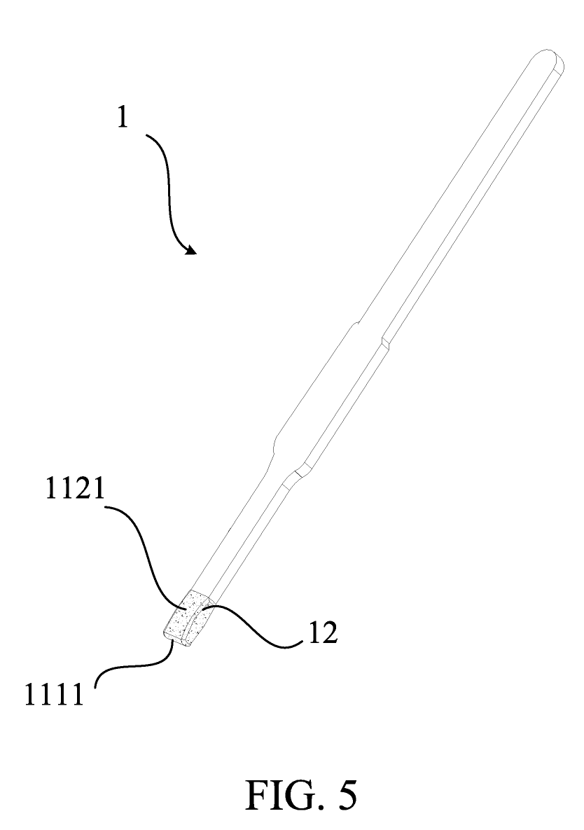

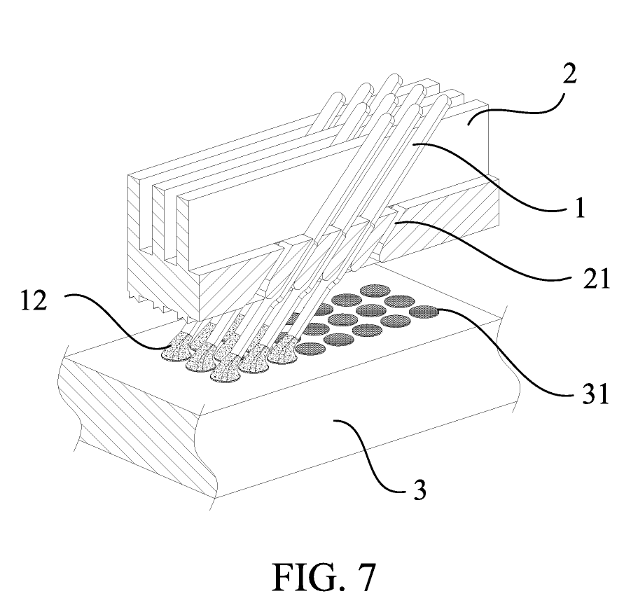

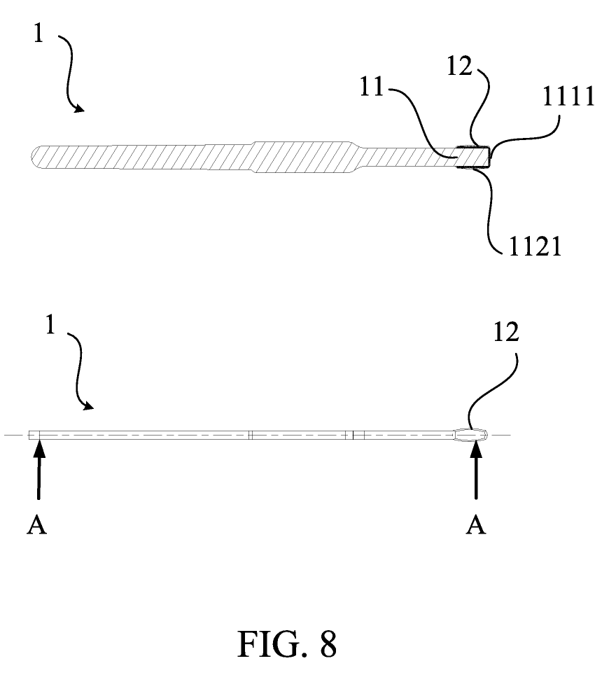

Please refer to FIG. 3 through FIG. 8. The conduction terminal 1 includes a base 10 and a weld part 11 extending from the base 10. The weld part 11 has an end surface 111 and a side wall 112 extending from the end surface 111 toward the base 10. A solder film 12 wraps the end surface 111 and the side wall 112 of the weld part 11. The solder film 12 wraps the surface of the weld part 11 of the conduction terminal 1 at a thin film. A weld region 1111 is defined on the solder film 12 on the end surface 111 of the weld part 11. The solder film 12 of the weld region 1111 is thicker than the solder film 12 of other regions on the end surface 111. Meanwhile, a weld region 1121 is defined on the solder film 12 on the side wall 112, and the solder film 12 of the weld region 1121 is thicker than the solder film 12 of other regions on the side wall 112.

There are a plurality of accommodation holes 21 on the insulation body 2 and corresponding to the conduction terminals 1. The accommodation holes 21 are arranged at a tilt. The conduction terminals 1 are accommodated in the accommodation holes 21 of the insulation body 2, and a connector is welded on the substrate 3 by the weld parts 11 of the conduction terminals 1.

Please refer to FIG. 3 through FIG. 5. The solder film 12 on the weld part 11 of the conduction terminal 1 of the invention can be manufactured by the following steps of: providing a fixture 4 having a plurality of storage troughs 41, therein sizes of storage troughs are the same, and; respectively depositing equivalent quantities of solders 5 in the storage troughs 41, therein the quantity of the solder 5 is enough for a siphon force of the weld part 11 of the conduction terminal 1 to break a surface tension of the end surface 111 of the weld part 11.

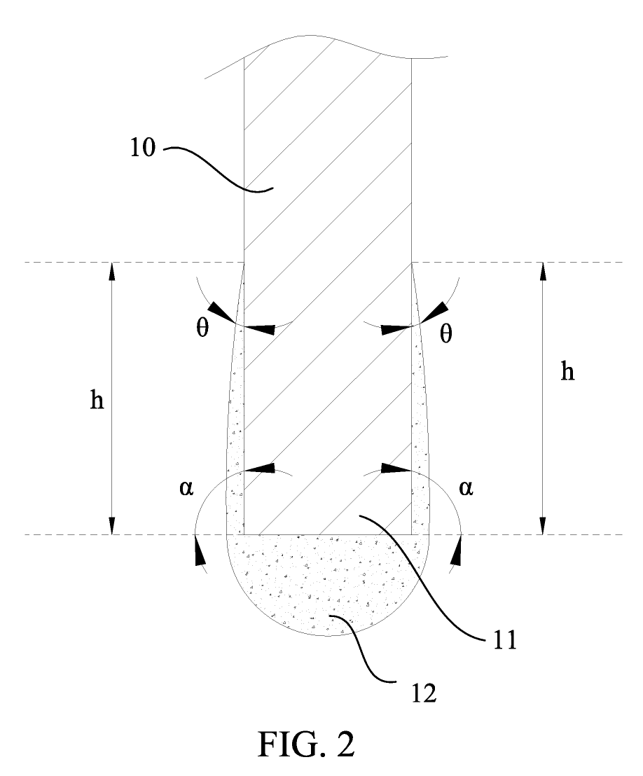

Please refer to FIG. 2. The solder 5 in the storage trough 41 of the fixture 4 climbs along the conduction terminal 1 because of a siphon force. During a tin-dipping process for the conduction terminal 1, a contact angle θ forms between the solder 5 and the conduction terminal 1, therein the contact angle θ means an included angle between the interface of the solder 5 and the substrate (i.e. the conduction terminal 1) and a tangent of a surface of the solder 5 after melting. Besides, the contact angle θ varies with the temperature and the materials of the solder 5 of the conduction terminal 1. A chamfer angle α is formed on the conduction terminal 1. The solder 5 climbs along the conduction terminal 1 to a height h because of a siphon force, and the height h varies with the contact angle θ and the chamfer angle α. The relation between h, θ, and α is shown as below:

$$h = a * \sqrt{1 - cos ( α - θ )} , therein a = \sqrt{\frac{2 σ}{ρ g}} ;$$

h represents a height that a solder 5 climbs along the conduction terminal 1 because of a siphon force; a represents a siphon constant; U represents a siphon force between the conduction terminal 1 and the solder 5; p represents a density of the solder 5; g represents a gravity acceleration.

According to the aforesaid relation, when the chamfer angle α is close to 90 degrees, and the contact angle θ is fixed, the solder 5 will stick on the conduction terminal 1. The conduction terminal 1 does not interrupt the climbing of the solder 5, and the solder 5 climbs along the conduction terminal 1. A siphonage phenomenon therefore occurs.

When 0 degree <α<90 degrees, the conduction terminal 1 interrupts the climbing of the solder 5 in some degree, but the solder 5 still can climb along the conduction terminal 1.

When the chamfer angle α of the conduction terminal 1 is close to the contact angle θ, the height h is close to 0. The conduction terminal 1 interrupts the climbing of the solder 5 completely, and the solder 5 does not climb along the conduction terminal 1, whereby a siphonage can be controlled.

Therefore, in a practical operation process, the contact angle θ can be controlled, and a structure of the conduction terminal 1 can be designed according to the contact angle θ so as to control the height h. During the tin-dipping process for the weld part 11 of the conduction terminal 1, the quantity of the solder 5 in the storage trough 41 of the fixture 4 is enough for a siphonage occurring on the weld part 11 of the conduction terminal 1, and is also the amount of the solder films 12 of the first weld region 1111 and the second weld region 1121 respectively formed on the end surface 111 and on the side wall 112 of the weld part 11.

The quantity of the solder 5 for a siphonage occurring on the whole weld part 11 that is predefined a length of the conduction terminal 1 is a minimum quantity for a siphon force of the weld part 11 capable of breaking a surface tension of the solder 5. Therefore, the length of the weld part 11 of the conduction terminal 1 and the quantity of the solder 5 can be predefined to control a specific thickness and length of the solder film 12 on the weld part 11 and the formation of the first weld region 1111 and the second weld region 1121.

The formation of the weld part 11 of the conduction terminal 1 includes the following steps of: plating a layer of easily welded and oxidized material on a surface of a conduction terminal 1, therein a suitable material of the layer is nickel; plating an layer of anti-oxidization material on a surface of a part region of the conduction terminal 1, therein a suitable material of the layer is gold or palladium, a weld part 11 is then formed, and other regions without the anti-oxidization layer on the surface of the conduction terminal 1 form an anti-weld region; and inserting the weld part 11 into the storage trough 41, such that the solder 5 sticks as a solder film 12 on a surface of the weld part 11 of the conduction terminal 1, and the weld part 11 is then formed. The length of the weld part 11 is long enough to break a surface tension of the solder 5, and the solder film 12 is formed after the solder 5 cooling.

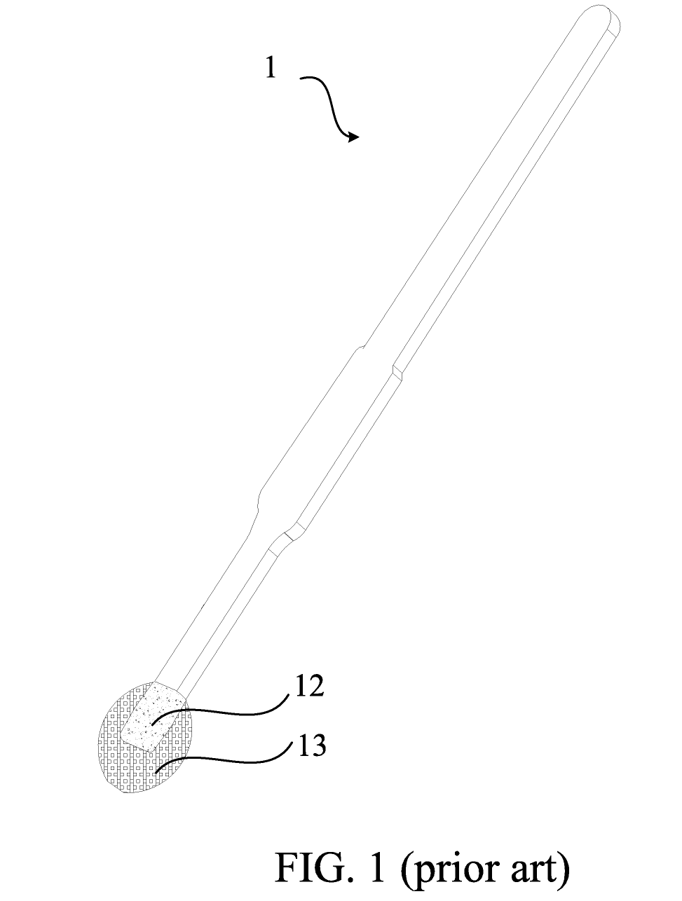

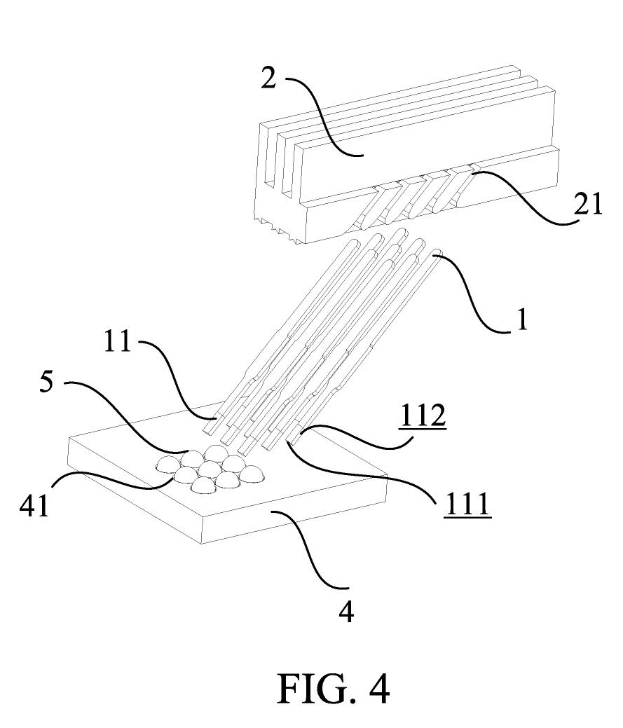

Please refer to FIG. 1 and FIG. 4. The solder on the weld part 11 of conduction terminal 1 of the invention includes the solder film 12, but does not include a solder 13 that can be capable of forming a tin-ball on the weld part 11. The invention provides a manufacture method utilizing a siphon force to break a surface tension of a solder film 12 on an end surface 111 of a weld part 11, and improves a fixture 4 and a process for supplying a fixed quantity of a solder 5. Therefore, a solder 13 capable of forming a tin-ball on the weld part 11 can be removed.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A conduction terminal, comprising:
a base;
a weld part, extending from the base, the weld part having an end surface and a side wall adjacent to the end surface; and
a solder, comprising a first solder film wrapping the end surface and a second solder film wrapping the side wall, a first weld region being defined on a surface of the first solder film, a second weld region being defined on a surface of the second solder film.

2. The conduction terminal of claim 1, wherein the second solder film enwraps the side wall of the weld part.

3. The conduction terminal of claim 1, wherein the second weld region is defined annularly on the surface of the second solder film.

4. The conduction terminal of claim 1, wherein a volume of the second weld region is larger than a volume of the first weld region.

5. The conduction terminal of claim 1, wherein the first weld region is defined as a hill on the surface of the first solder film.

6. The conduction terminal of claim 1, wherein the second weld region is defined as a hill on the surface of the second solder film.

7. The conduction terminal of claim 1, wherein at least one edge of the surface of the first solder film connects to the surface of the second solder film.

8. The conduction terminal of claim 1, wherein edges of the first weld region conjoin the surface of the first solder film.

9. The conduction terminal of claim 1, wherein edges of the second weld region conjoin the surface of the second solder film.

10. A method for tin-dipping a conduction terminal, comprising the following steps of:
providing a fixture having a plurality of storage troughs;
depositing a solder in the storage troughs, a surface tension of the solder stored in each of the storage troughs being able to be broken by a siphon force of a weld part of the conduction terminal predestined to be tin-dipped;
heating the fixture to melt the solder stored in each of the storage troughs; and
dipping the weld part of the conduction terminal into the storage trough, such that the solder sticks on the conduction terminal so as to form solder films respectively on an end surface and a side wall of the weld part, and the surface tension of the solder is broken by the siphon force of the weld part so as to form weld regions respectively on surfaces of the solder films.

11. The method of claim 10, wherein the storage troughs of the fixture are on a horizontal.

12. The method of claim 10, wherein sizes of the storage troughs are the same, and quantities of the solders stored in the storage troughs are the same.

13. The method of claim 10, wherein an oxidation material of an anti-weld region is nickel.

14. The method of claim 10, wherein an anti-oxidation material of the weld region is gold or palladium.
